(19) United States
(12) Patent Application Publication
(10) Pub. No.: US 2007/0212424 A1
(43) Pub. Date: Sep. 13, 2007

(54) Method of disinfecting food and food preparation areas

(76) Inventor: Paul Wegner, San Carlos, CA (US)

Correspondence Address: BENASUTTI, P.A., 17294 BERMUDA VILLAGE DRIVE, BOCA RATON, FL, 33487, US

(21) Appl. No.: 11/800,251

(22) Filed: May 4, 2007

Related U.S. Application Data
(63) Continuation of application No. 10/984,382, filed on Nov. 9, 2004.
Application No. 10/984,382 is a continuation-in-part of application No. 10/359,942, filed on Feb. 6, 2003, now Pat. No. 6,815,408.
(60) Provisional application No. 60/355,601, filed on Feb. 11, 2002.

(51) Int. Cl. A01N 1/00; A23L 3/3454

(52) U.S. Cl. 424/601; 422/28

(57) ABSTRACT

Hydrogen peroxide is stabilized by the addition of tri-potassium phosphate at a pH above 9.5. This enhanced product is environmentally friendly and can be used in a variety of odor and disinfection applications without hazard to people, plants and things. Such applications include food and food preparation areas.

### CROSS-REFERENCE TO RELATED APPLICATIONS

This application is a Continuation of my prior co-pending application, entitled HYDROGEN PEROXIDE STABILIZER AND RESULTING PRODUCT AND APPLICATIONS, Ser. No. 10/984,382, filed Nov. 9, 2004; which is a Continuation-in-Part of my prior application, entitled HYDROGEN PEROXIDE STABILIZER AND RESULTING PRODUCT AND APPLICATIONS, Ser. No. 10/359,942, filed Feb. 6, 2003, which is a Continuation-in-Part of my prior co-pending application, entitled HYDROGEN PEROXIDE STABILIZER, Ser. No. 60/355,601, filed Feb. 11, 2002; the disclosures of which are incorporated herein by reference as if fully set forth.

### BACKGROUND OF THE INVENTION

1. Technical Field

This invention relates to the disinfection food preparation areas and food.

2. Background Art

It is desirable to have an agent whose oxidation power is just short of being able to bleach and destroy the food itself, but strong enough to disinfect food and food preparation areas; without leaving an objectionable order or taste. Generally, as the pH increases and the oxidation power increases, the ability to disinfect articles also increases. Many odors can be reduced or eliminated with oxidation agents, but they are destructive to fibers, impart an unpleasant odor, and are toxic to the environment.

### DISCLOSURE OF THE INVENTION

### Summary of the Invention

I have invented a method of disinfecting food preparation areas comprising adding tri-potassium phosphate at a pH of equal to or greater than 9.5 to hydrogen peroxide to form a mixture and then treating the areas with the mixture.

I have also invented a method of disinfecting food comprising adding tri-potassium phosphate at a pH of equal to or greater than 9.5 to hydrogen peroxide to form a mixture and then treating the food with the mixture

### DESCRIPTION OF THE PREFERRED EMBODIMENTS

The product consists of three components: hydrogen peroxide; water as a diluent; and an alkaline phosphate, most preferably, tri-potassium phosphate at a pH greater than 9.5. The salt acts as a stabilizer and accelerator. Additional agents or conditioners can be added to increase its oxidation speed. For example, the addition of potassium saturated fatty acid salts to tri-potassium phosphate and hydrogen peroxide further enhances the stability of the hydrogen peroxide in excess of one year and a pH of about 10.5. The acceptable potassium salts are in the range of C10 to C30. The preferred salt is potassium sterate.

It is preferred that all the components be free or have low concentrations of materials which can contribute to the decomposition of hydrogen peroxide, such as organic matter, transition metals, and other material.

The most preferred salt is tri-potassium phosphate at a pH greater than 9.5. It provides a high level of stabilization to the hydrogen peroxide, while maintaining reasonable oxidation activity (bleaching action). A pH of less than 9 leads to poor disinfection and bleaching properties

Pharmaceutical grade hydrogen peroxide (3.5% hydrogen peroxide to water by weight) yields the most stable activated hydrogen peroxide. The best formulation is: tri-potassium phosphate at 1 to 10 grams per liter of 3.5% hydrogen peroxide. Four grams per liter is the most preferred. Higher concentrations of both components can be used, but the mixture becomes progressively more unstable.

Typically, distilled water is mixed with tri-potassium phosphate. Hydrogen peroxide 35% is added to the resulting solution. One part hydrogen peroxide to 9 parts water is preferred. The product can be used directly or diluted with distilled or with de-ionized water. Alternately, to maximize storage life, the product can be packaged as two separate components of stabilized hydrogen peroxide and water containing tri-potassium phosphate. These two components can be mixed prior to use, or applied sequentially.

Additional agents can be added to the product to enhance its oxidation speed. Once applied, the product can be exposed to light or heat to accelerate the oxidation speed. These agents are favored because they can be employed at the point of application and do not add chemicals to the product; which means increased storage life and less chemical residue. The best way to enhance effectiveness of the product is by simple evaporation after application. The hydrogen peroxide concentration increases along with its activity, with minimal decomposition.

In terms of chemical accelerators, potassium hydroxide is the material of choice. It increases oxidation speed of the product the most with the least amount of decomposition. These accelerators can be combined with the product, or applied at the point of use.

Other useful accelerators are potassium carbonate, sodium hydroxide, sodium carbonate, ammonium hydroxide, and ethanol amine.

Product Compositions

In general, hydrogen peroxide concentration required for odor control and disinfection is lower than that required for bleaching out stains. A hydrogen peroxide concentration of 0.1% up to 8% is sufficient for many applications, without being corrosive or difficult to transport and store. High concentrations are useful, but less safe to handle.

The tri-potassium phosphate (stabilizer-accelerator) is added at a level sufficient to promote adequate stabilization and activity. A level of 100 PPM to 2,000 PPM for a hydrogen peroxide of about 4% is sufficient. Concentrations may be modified individually for other applications.

Chemical accelerators should be added in amounts just sufficient to achieve the desired oxidation speed. This amount could be 10 times higher than the stabilizer-accelerator.

The water, stabilizer-accelerator, and optional chemical accelerator should be combined first, followed by the slow addition of the hydrogen peroxide. Cold and dark mixing and storage conditions are favored.

Potassium saturated fatty acid salts can be added to enhance the degreasing properties of the agent without harming the stability of the activated hydrogen peroxide.

The tri-potassium phosphate can be added to the hydrogen peroxide as a dry powder to produce the activated hydrogen peroxide. It is more convenient to ship the dry powder.

Less preferred salts are: dipotassium phosphate, tetra potassium pyrophosphate, potassium polyphosphate, disodium phosphate trisodium phosphate, tetra sodium pyrophosphate, sodium polyphosphate, diammonium phosphate, tri-ammonium phosphate, tetra ammonium pyrophostate, and ammonium polyphosphate. These are functional, but less acceptable due to reduced stabilization, oxidation speed, odor acceptability, or taste acceptability. These phosphate salts can also be formed in situ by reacting alkaline materials such as potassium hydroxide with the phosphoric acid stabilizer that is present in some stabilized hydrogen peroxide sources. Sodium salts can be toxic to some plants.

Alternately, a concentrated form of hydrogen peroxide 35% to 90% can be diluted with pure water or with pure water containing the phosphate salt stabilizer.

Distilled water or de-ionized water is the preferred diluent.

Methods of Application

In many cases, the product can be applied as a spray or fine aerosol. It is most effective when applied and allowed to dry at room temperature. The product becomes more active as the water evaporates and hydrogen peroxide becomes more concentrated. In many cases, no rinsing is necessary because of the low solid residue. In some cases, the totally dissolved solids (TDS) level meets potable water standards. In addition, no organic soap residues are introduced; which could act as food sources for odor causing bacteria, decompose into odiferous materials, or cause subsequent dirt to stick to the article being cleaned.

The product can be applied as a liquid to articles such as textiles, paper pulp, hair bleach and dye, as a tooth bleach, for mouthwash, water disinfection, wash water, pools, saunas, and spas.

The application of light or heat accelerates the action of the product. These methods of acceleration are preferred over the addition of chemical accelerators, because they can be easily introduced at the time of application and do not add to the residue level. The addition of chemical accelerators such as potassium hydroxide should be added close to the time of use to maximize the shelf life of the hydrogen peroxide. Chemical accelerators generally increase the activity of the hydrogen peroxide at the expense of increased hydrogen peroxide loss from decomposition into oxygen gas.

Specific Applications:

Food, Agricultural Products, and Food Contact Disinfection and Deodorization

In many cases, it is desirable to disinfect food and food contact areas without affecting the taste of the food being handled. Presently, chlorine-based bleaches, such a chlorine, bromine, and iodine based products are the accepted disinfection agents. All these materials can impart a bad taste, are toxic, can produce toxic chemicals, or otherwise render the food products unacceptable. Examples of these areas are dairies, bottling plants, canneries, meat processing, agricultural product washing, food processing plants, and restaurants. The product can be applied to these areas to reduce odor and increase the level of sanitation without the risk of toxicity or imparting a bad taste to the items, due to product residues. It can also be applied to a food item itself.

Positive Attributes of My Product
Disinfects;
Useful in mold and mildew abatement;
Kills some insects;
Emulsifies to help remove oils and greases;
Removes dirt;
Odorless and does not create unpleasant odors when applied;
Colorless and clear;
Leaves no organic (soap, perfume, enzyme) residue;
Leaves only trace amounts of inorganic residue;
No perfumes;
Non-foaming;
Does not impart an unpleasant taste to many foods and agricultural products;
Environmentally friendly, since it decomposes into plant food and water;
Can be applied as an aerosol in the presence of people and animals;
Good buffering at high pH;
Nontoxic to plants and animals; and
Good stability.

In addition, it provides the following benefits, at the concentration in which it is applied:
Buffering action at high pH to ensure high oxidation activity;
Odorless;
Colorless;
Clear;
Acceptable taste at the concentrations in which it is applied;
Oil and grease emulsifier;
Non-foaming properties;
Dirt removing properties; and
Low toxicity to animals, plants, and the environment.

Product Storage

The preferred method of storage is in a cool, dark area and in vented containers.

Product Delivery

Fine aerosol, spray, or liquid. Vented containers, such as vented spray bottles, are preferred. I have disclosed a product comprising hydrogen peroxide and tri-potassium phosphate at a pH greater than 9.5. The tri-potassium phosphate can be in the range of 1 to 10 grams per liter of 3.5% hydrogen peroxide to water by weight and a pH of 9.5 to 10.0. The product the hydrogen peroxide can be in the range 1 part of 35% hydrogen peroxide to 9 parts water. The product further may comprise distilled water. The hydrogen peroxide can have a concentration in the range of 0.1% to 8%. The product may further comprise the addition of potassium saturated fatty acid salt and have an increased pH of about 10.

I have also invented a method of storing components for making a stabilized hydrogen peroxide by combining the components at a later date comprising the steps of storing an aqueous solution of hydrogen peroxide in one container and storing water containing tri-potassium phosphate in another container.

And a method of applying a product for odor control and disinfection to an air handling system comprising the step of introducing a product comprising hydrogen peroxide and tri-potassium phosphate into the intake of the air handling system.

And a method of increasing the oxidation speed of a product containing hydrogen peroxide comprising adding tri-potassium phosphate thereto.

What is claimed is:

1. A method of disinfecting food preparation areas comprising adding tri-potassium phosphate at a pH of equal to or greater than 9.5 to hydrogen peroxide to form a mixture and then treating the areas with the mixture.

2. A method of disinfecting food comprising adding tri-potassium phosphate at a pH of equal to or greater than 9.5 to hydrogen peroxide to form a mixture and then treating the food with the mixture
